(19) United States
(12) Patent Application Publication
(10) Pub. No.: US 2023/0012690 A1
(43) Pub. Date: Jan. 19, 2023

(54) SYSTEMS AND METHODS FOR HIGH THROUGHPUT VOLUMETRIC 3D PRINTING

(71) Applicant: QUADRATIC 3D, INC., Charlestown, MA (US)

(72) Inventor: Eric M. Arndt, Everett, MA (US)

(21) Appl. No.: 17/952,823

(22) Filed: Sep. 26, 2022

Related U.S. Application Data
(63) Continuation of application No. PCT/US2021/024878, filed on Mar. 30, 2021.
(60) Provisional application No. 63/003,078, filed on Mar. 31, 2020.

(51) Int. Cl. B29C 64/343; B33Y 10/00; B33Y 30/00; B33Y 40/00; B29C 64/357; B29C 64/129; B29C 64/259; B29C 64/379

(52) U.S. Cl. CPC B29C 64/343; B33Y 10/00; B33Y 30/00; B33Y 40/00; B29C 64/357; B29C 64/129; B29C 64/259; B29C 64/379

(57) ABSTRACT

A method of printing one or more three-dimensional objects comprises: providing a volume of a photopolymerizable liquid in a closed container including an entry port and an exit port, the entry port and the exit port being connected by a channel therebetween, the container including at least one printing zone comprising at least an optically transparent window to facilitate irradiating excitation light at a first wavelength into a printing zone through the at least an optically transparent window, wherein the photopolymerizable liquid displays non-Newtonian rheological behavior such that the object formed in the photopolymerizable liquid within the printing zone remains at a fixed position or is minimally displaced in the unpolymerized photopolymerizable liquid during formation, directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port. Systems for printing one or more three-dimensional objects are also disclosed.

### CROSS-REFERENCE TO RELATED APPLICATIONS

This application is a continuation of International Application No. PCT/US2021/024878 filed on Mar. 30, 2021, which International Application claims priority to U.S. Provisional Patent Application No. 63/003,078, filed on Mar. 31, 2020, each of which applications is hereby incorporated herein by reference in its entirety for all purposes.

### TECHNICAL FIELD OF THE INVENTION

The present invention relates to the technical field of three-dimensional printing.

### BRIEF SUMMARY OF THE INVENTION

In accordance with one aspect of the present invention, there is provided a system for printing one or more three-dimensional objects, the system comprising:

a closed container including an entry port and an exit port, the entry port and the exit port being connected by a channel therebetween, the closed container including a printing zone, wherein the printing zone comprises at least an optically transparent window to facilitate directing an excitation light into the printing zone through the optically transparent window to form a three-dimensional printed object within a volume of photopolymerizable liquid in the printing zone, and

a pump in connection with the entry port of the closed container and adapted for connection to a source of the photopolymerizable liquid, the pump being capable of pumping an amount of the photopolymerizable liquid into the closed container through the entry port.

Preferably the system is capable of being maintained in an inert atmosphere and wherein each connection and port is airtight.

Preferably the system is capable of being light tight except for the printing zone to reduce unwanted photopolymerization.

In accordance with another aspect of the present invention, there is provided a system for printing one or more three-dimensional objects, the system comprising:

a reservoir for containing a supply of a photopolymerizable liquid, the reservoir having a reservoir outlet and a reservoir inlet,

a pump in connection with the reservoir outlet for pumping an amount of the photopolymerizable liquid from the reservoir into a closed container through an entry port in the closed container,

the closed container including the entry port and an exit port, the entry port and the exit port being connected by a channel therebetween, the closed container including a printing zone, the printing zone comprising at least an optically transparent window to facilitate directing an excitation light at a first wavelength into the printing zone through the optically transparent window to form a three-dimensional printed object from the photopolymerizable liquid in the printing zone, and

a separator unit in connection with the exit port of the closed container for receiving contents discharged from the closed container, the separator unit being capable of separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

Preferably the system is capable of being maintained in an inert atmosphere and each of the connections and port are airtight.

Preferably the system is capable of being light tight except for the printing zone to reduce unwanted photopolymerization.

In accordance with yet another aspect of the present invention, there is provided a method of printing one or more three-dimensional objects, the method comprising:

providing a volume of a photopolymerizable liquid in a closed container including an entry port and an exit port, the entry port and the exit port being connected by a channel therebetween, the container including at least one printing zone comprising at least an optically transparent window to facilitate irradiating excitation light at a first wavelength into a printing zone through the at least an optically transparent window, wherein the photopolymerizable liquid preferably displays non-Newtonian rheological behavior such that the object formed in the photopolymerizable liquid within the printing zone remains at a fixed position or is minimally displaced in the unpolymerized photopolymerizable liquid during formation,

directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and

applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

The method can further include separating any printed objects from unpolymerized photopolymerizable liquid included in the discharged contents.

Optionally, the method further comprises recycling the separated unpolymerized photopolymerizable liquid from the discharged contents.

Preferably the method is carried out in an inert atmosphere.

Systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object without requiring the addition of support structures. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts.

Systems and methods in accordance with the present invention advantageously further do not require adhering the object being printed to a fixed substrate (e.g., build plate) at the beginning of the printing process avoiding a post-processing step of separating the printed object from the fixed substrate.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description and drawings, from the claims, and from practice of the invention disclosed herein.

### BRIEF DESCRIPTION OF THE DRAWINGS

In the drawings,

FIG. 1 depicts a diagram of an example of an embodiment of a system in accordance with an aspect of the present invention.

FIG. 2 depicts a diagram of an example of an embodiment of a system in accordance with an aspect of the present invention.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention relates to systems and methods for printing one or more three-dimensional objects.

In accordance with one aspect of the present invention, there is provided a system for printing one or more three-dimensional objects, the system comprising: a closed container including an entry port and an exit port, the entry port and the exit port being connected by a channel therebetween, the closed container including at least one printing zone, wherein a printing zone comprises at least an optically transparent window to facilitate directing an excitation light into a printing zone through the optically transparent window to form a three-dimensional printed object within a volume of photopolymerizable liquid in the printing zone, and a pump in connection with the entry port of the closed container and adapted for connection to a source of the photopolymerizable liquid, the pump being capable of pumping an amount of the photopolymerizable liquid into the closed container through the entry port.

Preferably the system is capable of being maintained in an inert atmosphere and wherein each connection and port is airtight.

Preferably the system is capable of being light tight except for the printing zone to reduce unwanted photopolymerization.

In use, the closed container is filled with a photopolymerizable liquid to be selectively photopolymerized in the printing zone to form a three-dimensional object.

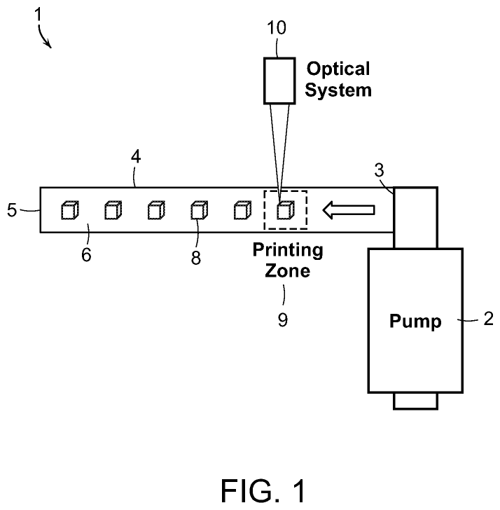

FIG. 1 depicts a diagram of an example of an embodiment of a system in accordance with an aspect of the present invention. The diagram depicts a system 1 including a pump 2 in connection with the entry port 3 of a closed container 4. The pump is adapted for connection to a source of photopolymerizable liquid (not shown). The closed container also includes an exit port 5. The entry port 3 and the exit port 5 are connected by a channel 6 therebetween. As depicted, the channel includes photopolymerizable liquid with a plurality of three-dimensional printed objects 8 therein, one of which is in the printing zone 9, the others spaced apart due to successive displacement from the printing zone toward the exit port by a series of separate additions of new amounts of photopolymerizable liquid pumped into the closed container by the pump. The arrow depicted in FIG. 1 indicates the direction of the flow of the photopolymerizable liquid in the channel from the entry point where the liquid is introduced into the closed container to the exit port through which contents are discharge from the closed container.

The system is preferably capable of being maintained in an inert atmosphere and each of the connections and ports are airtight.

Preferably the system is capable of being light tight except for the printing zone to reduce unwanted photopolymerization.

For illustration purposes, the channel portion of the closed container is depicted as optically transparent. While it may be desirable in some instances for the channel portion of the closed container or the entire closed container to be entirely optically transparent, at least a window in the closed container is optically transparent to facilitate passing excitation from an optical system into the photopolymerizable liquid in the printing zone to print an object.

In some instances it may be desirable for portions of the closed container adjacent a printing zone to not be optically transparent to help prevent excitation light from spreading into areas of the closed container outside the printing zone in which photopolymerization is not desired.

Additional information relating to the closed container and pump is provided below.

The system can further include an optical system 10 external to a printing zone of the closed container. The optical system can optionally be separately provided or can be included as part of the system in combination with the closed container and pump.

An optical system can be in connection with an excitation light source. The optical system is positioned or positionable to irradiate the excitation light through the at least optically transparent window of the printing zone.

FIG. 1 depicts an optical system positioned over a printing zone in the closed container.

Optionally, the optical system used with or included in the system can be movable in relation to the printing zone such that excitation light can be irradiated into the printing zone from one or more sides of the printing zone (e.g., from the top, one side, both sides, the bottom, or any combination including two or more sides). If a movable optical system is to be used, the printing zone will include transparent portions to accommodate irradiation of excitation light into the printing zone from one or more sides. For example, each side or surface of the printing zone through which the excitation light is to be irradiated will be optically transparent or at least include an optically transparent window through which the excitation light can pass.

Optionally, the excitation light can be temporally and/or spatially modulated. Optionally, the intensity of the excitation light can be modulated.

Spatially modulated excitation light can be created by known spatial modulation techniques, including, for example, a liquid crystal display (LCD), a digital micromirror display (DMD), or a microLED array. Other known spatial modulation techniques can be readily identifiable by those skilled in the art.

The optical system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light.

Preferably, the excitation light has a wavelength in the visible range.

The optical system can be movable in one or more of the x, y, and z directions in relation to a given printing zone.

Optionally a printing zone can be entirely optically transparent.

The system can optionally include more than one printing zone. Each printing zone will include at least an optically transparent window to facilitate the irradiation of excitation light into the photopolymerizable liquid in each printing zone. As discussed above, other portions or all of a printing zone can be optically transparent to accommodate the optical system to be used and its movability.

When the system includes more than one printing zone, the system can include an optical system associated with each printing zone. Alternatively, when the system includes more than one printing zone, the system can include an optical system that is movable in relation to at least the locations of the printing zones in the closed container and repositionable for irradiating excitation light into each of the printing zones, one at a time.

The system can optionally further include a separator unit (not shown in FIG. 1) in connection with the exit port of the closed container for receiving contents discharged from the closed container. The separator unit is for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit. Optionally, the second discharge port of the separator unit is adapted for connection to a return line or recirculation loop for recirculating the separated unpolymerized photopolymerizable liquid to the source of the photopolymerizable liquid to be pumped into the closed container.

The separator unit is preferably sealed to prevent introduction of air or oxygen into the unit during separation.

The separator unit preferably mechanically separates any printed objects from the unpolymerized photopolymerizable liquid in the contents discharged from the closed contained. Examples of techniques for mechanically separating print objects from unpolymerized photopolymerizable liquid in the discharged contents include, but are not limited to, screening techniques, use of a scoop or claw to extract any printed objects from the discharged contents, a cyclonic separator, a spiral separator; and a combination of two or more techniques.

The separated unpolymerized photopolymerizable liquid can be treated after separation from any printed objects. Examples of such treatments include, without limitation, cleaning/purification, filtering, degassing, or solvent, monomer addition.

The printed objects collected from the separator unit can optionally be post-treated.

Examples of post-treatments include, but are not limited to, washing, post-curing (e.g., by light, heat, non-ionizing radiation, ionizing radiation, pressure, or simultaneous or sequential combinations of techniques), metrology, freeze-dry processing, critical point drying, and packaging.

In accordance with another aspect of the present invention, there is provided a system for printing one or more three-dimensional objects, the system comprising: a reservoir for containing a supply of a photopolymerizable liquid, the reservoir having a reservoir outlet and a reservoir inlet, a pump in connection with the reservoir outlet for pumping an amount of the photopolymerizable liquid from the reservoir into a closed container through an entry port in the closed container, the closed container including the entry port and an exit port, the entry port and the exit port being connected by a channel therebetween, the closed container including at least one printing zone, a printing zone comprising at least an optically transparent window to facilitate directing an excitation light at a first wavelength into a printing zone through the optically transparent window to form a three-dimensional printed object from the photopolymerizable liquid in the printing zone, and a separator unit in connection with the exit port of the closed container for receiving contents discharged from the closed container. The separator unit is capable of separating any printed objects from unpolymerized photopolymerizable liquid included in the discharged contents. The separator unit also feeds any separated printed objects out of the separator unit through a first discharge port for collection and/or post-treatment. The separator unit also includes a second discharge port for discharging the separated unpolymerized photopolymerizable liquid from the separator unit. Optionally, the separator unit further includes a return line or recirculation loop in connection with the second discharge port for recirculating the separated unpolymerized photopolymerizable liquid to the reservoir,

Preferably the system is capable of being maintained in an inert atmosphere and each of the connections and ports are airtight.

Preferably the system is capable of being light tight except for the printing zone to reduce unwanted photopolymerization.

In use, the closed container is filled with a photopolymerizable liquid to be selectively photopolymerized in the printing zone to form a three-dimensional object.

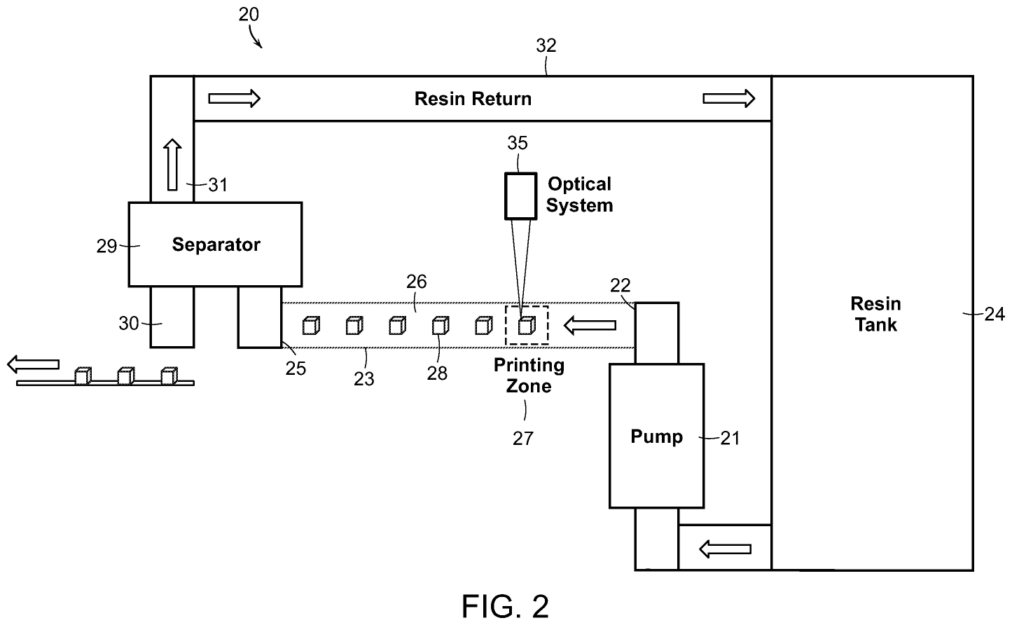

FIG. 2 depicts a diagram of an example of an embodiment of a system in accordance with an aspect of the present invention. The diagram depicts a system 20 including a pump 21 in connection with the entry port 22 of a closed container 23. The pump is adapted for connection to a reservoir (labeled “Resin Tank” in the FIG. 24 for containing a photopolymerizable liquid. The closed container also includes an exit port 25. The entry port 22 and the exit port 25 are connected by a channel 26 therebetween. As depicted, the channel includes photopolymerizable liquid with a plurality of three-dimensional printed objects 28 therein, one of which is in the printing zone 27, the others spaced apart due to successive displacement from the printing zone toward the exit port by a series of separate additions of new amounts of photopolymerizable liquid pumped into the closed container by the pump. The arrow depicted in FIG. 2 indicates the direction of the flow of the photopolymerizable liquid in the channel from the entry point where the liquid is introduced into the closed container to the exit port where contents are discharge from the closed container. The displaced contents include unpolymerized photopolymerizable liquid and any printed object included therein that has been displaced from the printing zone and transported along the length of the channel to the exit port through a series of additions of new photopolymerizable liquid into the closed container by the pump. The discharged contents exit the closed container through the exit port and pass into a separator unit (labeled “Separator” in the figure) 29 in connection with the exit port. The separator unit is capable of separating any printed objects from unpolymerized photopolymerizable liquid included in the discharged contents. The separator unit also feeds any separated printed objects out of the separator unit through a first discharge port 30 for collection and/or post-treatment. The separator unit also includes a second discharge port 31 for discharging the separated unpolymerized photopolymerizable liquid from the separator unit.

The separator unit is preferably sealed to prevent introduction of air or oxygen into the unit during separation.

The separator unit preferably mechanically separates any printed objects from the unpolymerized photopolymerizable liquid in the contents discharged from the closed contained. Examples of techniques for mechanically separating print objects from unpolymerized photopolymerizable liquid in the discharged contents include, but are not limited to, screening techniques, use of a scoop or claw to extract any printed objects from the discharged contents, a cyclonic separator, a spiral separator; and a combination of two or more techniques.

The separated unpolymerized photopolymerizable liquid can be treated after separation from any printed objects. Examples of such treatments include, without limitation, cleaning/purification, filtering, degassing, or solvent, monomer addition.

Optionally, the system further includes a return line or recirculation loop (labeled “Resin Return” in the FIG. 32 in connection with the second discharge port 31 of the separator unit for recirculating the separated unpolymerized photopolymerizable liquid to the reservoir 24.

The printed objects collected from the separator unit can optionally be post-treated. Examples of post-treatments include, but are not limited to, washing, post-curing (e.g., by light, heat, non-ionizing radiation, ionizing radiation, pressure, or simultaneous or sequential combinations of techniques, metrology, freeze-dry processing, critical point drying, and packaging.

For illustration purposes, the channel portion of the closed container is depicted as optically transparent.

While it may be desirable in some instances for the channel portion of the closed container or the entire closed container to be entirely optically transparent, at least a window in the closed container is optically transparent to facilitate passing excitation from an optical system into the photopolymerizable liquid in the printing zone to print an object.

In some instances it may be desirable for portions of the closed container adjacent a printing zone to not be optically transparent to help prevent excitation light from spreading into areas of the closed container outside the printing zone in which polymerization is not desired.

Additional information relating to the closed container and pump is provided below.

The system can further include an optical system 35 external to a printing zone of the closed container. The optical system can optionally be separately provided or can be included as part of the system in combination with the closed container and pump.

An optical system can be in connection with an excitation light source. The optical system is positioned or positionable to irradiate the excitation light through the at least optically transparent window of the printing zone.

FIG. 2 depicts an optical system positioned over a printing zone in the closed container.

Optionally, the optical system used with or included in the system can be movable in relation to the printing zone such that excitation light can be irradiated into the printing zone from one or more sides of the printing zone (e.g., from the top, one side, both sides, the bottom, or any combination including two or more sides). If a movable optical system is to be used, the printing zone will include transparent portions to accommodate irradiation of excitation light into the printing zone from one or more sides. For example, each side or surface of the printing zone through which the excitation light is to be irradiated will be optically transparent or at least include an optically transparent window through which the excitation light can pass.

Optionally, the excitation light can be temporally and/or spatially modulated. Optionally, the intensity of the excitation light can be modulated.

Spatially modulated excitation light can be created by known spatial modulation techniques, including, for example, a liquid crystal display (LCD), a digital micromirror display (DMD), or a microLED array. Other known spatial modulation techniques can be readily identifiable by those skilled in the art.

The optical system can be selected to apply continuous excitation light. The optical system can be selected to apply intermittent excitation light. Intermittent excitation can include random on and off application of light or periodic application of light. Examples of periodic application of light includes pulsing. The optical system can be selected to apply a combination of both continuous excitation light and intermittent light, including, for example, an irradiation step that includes the application of intermittent excitation light that is preceded or followed by irradiation with continuous light.

Preferably, the excitation light has a wavelength in the visible range.

The optical system can be movable in one or more of the x, y, and z directions in relation to a given printing zone.

Optionally a printing zone can be entirely optically transparent.

The system can optionally include more than one printing zone. Each printing zone will include at least an optically transparent window to facilitate the irradiation of excitation light into the photopolymerizable liquid in each printing zone. As discussed above, other portions or all of a printing zone can be optically transparent to accommodate the optical system to be used and its movability.

When the system includes more than one printing zone, the system can include an optical system associated with each printing zone. Alternatively, when the system includes more than one printing zone, the system can include an optical system that is movable in relation to at least the locations of the printing zones in the closed container and repositionable for irradiating excitation light into each of the printing zones, one at a time.

In accordance with yet another aspect of the present invention, there is provided a method of printing one or more three-dimensional objects. The method includes providing a volume of a photopolymerizable liquid in a closed container. The photopolymerizable liquid preferably displays non-Newtonian rheological behavior such that the object formed in the photopolymerizable liquid within the printing zone remains at a fixed position or is minimally displaced in the unpolymerized photopolymerizable liquid during formation. The closed container includes an entry port and an exit port, the entry port and the exit port being connected by a channel therebetween. The closed container also includes at least one printing zone in which the object is formed. Each printing zone includes at least an optically transparent window through which excitation light at a first wavelength can be irradiated into a printing zone. The method also includes directing the excitation light through the at least an optically transparent window into the printing zone to selectively photopolymerize the photopolymerizable liquid in the printing zone without the addition of support structures to form a printed object. The printed object remains at a fixed position or is minimally displaced in the unpolymerized photopolymerizable liquid during formation. The method further includes applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

The method can further include separating any printed objects from unpolymerized photopolymerizable liquid included in the discharged contents.

Optionally, the method further comprises recycling the separated unpolymerized photopolymerizable liquid from the discharged contents.

Preferably the method is carried out in an inert atmosphere.

In one example of the method, 1) a resin is photocured without support structures so that the part is suspended in resin; 2) the resin is thixotropic (shear-thinning) or has a yield stress, such that during the curing operation the part remains fixed in space or undergoes a minimal amount of displacement; 3) upon application of pressure the cured part or parts are pumped out of the printing zone and the printing zone is refilled with new resin; 4) the parts are separated from the resin; and 5) the resin is optionally recycled.

The method of the present invention can produce one or more printed objects utilizing light-induced solidification of a photopolymerizable liquid that includes a photopolymerizable component which displays non-Newtonian rheological behavior. Examples of such non-Newtonian rheological behavior include pseudoplastic fluid, yield pseudoplastic, or Bingham plastic. This behavior may be intrinsic to the combination of reactive components in the resin (monomers and oligomers) or imparted by a nonreactive additive (thixotrope, rheology modifier). Formulation of photopolymerizable components that display non-Newtonian behavior is within the skill of skilled artisan in the relevant art. Examples include a formulation of a photopolymerizable liquid for use in the present method includes 86 parts GENOMER 4259 (an aliphatic urethane acrylate), 14 parts N,N-dimethylacrylamide, 13.3 parts 60 wt % nanoparticle dispersion in N,N-dimethylacrylamide, 2 parts Rheobyk 410 thixotrope, 0.5 parts Bis(2,6-difluoro-3-(1-hydropyrrol-1-yl)phenyl)titanocene photoinitiator, 0.0001 parts 2,2,6,6-Tetramethyl-1-piperidinyloxy free radical inhibitor.

The printed object is formed in a volume of photopolymerizable liquid by application of light in a printing zone, without the production of support structures, and due to the rheological behavior (high zero-shear viscosity or yield stress), the part displaces by a minimal amount that is acceptable for precisely reproducing the intended part geometry during the time interval required to form the part. Once the part is formed, the part is displaced from the printing zone by applying pressure and/or pumping additional photopolymerizable liquid into the closed container, which causes the photopolymerizable liquid to flow. While the object experiences little or no displacement during formation in the printing zone, when the object is displaced from the printing zone by pumping pressure and/or the addition of additional photopolymerizable liquid to the closed container, it may experience positional displacement in the contents as it is moved toward the exit port.

For photopolymerizable liquids that display non-Newtonian rheological behavior, preferred steady shear viscosities are less than 10,000 cP and most preferably less than 1,000 cP. (Steady shear viscosity refers to the viscosity after the thixotrope network has broken up.)

Methods in accordance with the present invention are additionally particularly useful for printing 3D objects from photopolymerizable liquids that demonstrate non-Newtonian behavior and which can be solidified at volumetric positions impinged upon by excitation light at a first wavelength by upconversion-induced photopolymerization.

Preferably the photopolymerizable liquid includes (i) a photopolymerizable component; (ii) upconverting nanoparticles including a sensitizer and a annihilator, the sensitizer comprising molecules selected to absorb light at the first wavelength and generate triplet excitons and the annihilator being selected to emit light at a second wavelength after transfer of energy from the sensitizer to the annihilator, the second wavelength being shorter than the first wavelength; and (iii) a photoinitiator that initiates polymerization of the photopolymerizable component upon excitation by light at the second wavelength, wherein the photopolymerizable liquid demonstrates non-Newtonian behavior.

As discussed herein, a photopolymerizable liquid can preferably include: a photopolymerizable component; upconverting nanoparticles including a core portion that includes a sensitizer and an annihilator in a liquid (e.g., oleic acid) and an encapsulating coating or a shell (e.g., silica) over at least a portion, and preferably substantially all, the outer surface of the core portion, wherein the sensitizer comprises a molecule selected to absorb light at the first wavelength and generate triplet excitons and the annihilator being selected to emit light at a second wavelength after transfer of energy from the sensitizer to the annihilator, the second wavelength being shorter than the first wavelength; and a photoinitiator that initiates polymerization of the photopolymerizable component upon excitation by light at the second wavelength. The upconverting nanoparticles can further include ligands at the surface thereof for facilitating distribution of the nanoparticles in the photopolymerization component. Surfactants and other materials useful as ligands are commercially available. Examples of ligands include, but are not limited to, poly-ethylene glycols.

An annihilator may also be referred to as a triplet annihilator.

Upconverting nanoparticles preferably have an average particle size less than the wavelength of the exciting light. Examples of preferred average particle sizes are less than 100 nm, less than 80 nm, less than 50 nm, less than 30 nm, less than 20 nm, although still larger, or smaller, nanoparticles can also be used. Most preferably, the upconverting nanoparticles have an average particle size that creates no appreciable light scattering.

Examples of materials for use as sensitizers and annihilators are described in International Application No. PCT/US2019/063629, of Congreve, et al., filed Nov. 27, 2019, S. Sanders, et al., “Photon Upconversion in Aqueous Nanodroplets”, J. Amer. Chem. Soc. 2019, 141, 9180-9184, and Beauti, Sumar, Abstract entitled “Search for New Chromophore Pairs for Triplet-Triplet Annihilation Upconversion” ISEF Projects Database, Finalist Abstract (2017), available at https://abstracts.societyforscience.org, each of the foregoing being hereby incorporated herein by reference in its entirety. WO2019/025717 of Baldeck et al., published Feb. 7, 2019, and International Application No. PCT/US2019/063629, of Congreve, et al., filed Nov. 27, 2019 also provide information that may be useful concerning the concentration of the upconverting nanoparticles and the concentrations of the sensitizer and annihilator in the photopolymerizable liquid.

An annihilator can comprise molecules capable of receiving a triplet exciton from a molecule of the sensitizer through triplet-triplet energy transfer, undergo triplet fusion with another annihilator molecule triplet to generate a higher energy singlet that emits light at a second wavelength to excite the photosensitizer to initiate polymerization of the photopolymerizable component. Examples of annihilators include, but are not limited to, polycyclic aromatic hydrocarbons, e.g., anthracene, anthracene derivatives (e.g., diphenyl anthracene (DPA), 9,10-dimethylanthracene (DMA), 9,10-dipolyanthracene (DTA), 2-chloro-9,10-diphtylanthracene (DTACI), 2-carbonitrile-9,10-dip tetrylanthracene (DTACN), 2-carbonitrile-9,10-dinaphthylanthracene (DNACN), 2-methyl-9,10-dinaphthylanthracene (DNAMe), 2-chloro-9,10-dinaphthylanthracene (DNACI), 9,10-bis (phenylethynyl) anthracene (BPEA), 2-chloro-9,10-bis (phenylethynyl) anthracene (2CBPEA), 5,6,11,12-tetraphenylnaphthacene(rubrene), pyrene and or perylene (e.g., tetra-t-butyl perylene (TTBP). The above anthracene derivatives may also be functionalized with a halogen. For example, DPA may be further functionalized with a halogen (e.g., fluorine, chlorine, bromine, iodine). Fluorescent organic dyes can be preferred.

A sensitizer can comprise at least one molecule capable of passing energy from a singlet state to a triplet state when it absorbs the photonic energy of excitation at the first wavelength. Examples of sensitizers include, but are not limited to, metalloporphyrins (e.g., palladium tetraphenyl tetrabutyl porphyrin (PdTPTBP), platinum octaethyl porphyrin (PtOEP), octaethyl-porphyrin palladium (PdOEP), palladium-tetratolylporphyrin (PdTPP), palladium-meso-tetraphenyltetrabenzoporphyrin 1 (PdPh4TBP), 1,4,8,11,15,18,22,25-octabutoxyphthalocyanine (PdPc (OBu)), 2,3-butanedione (or diacetyl), or a combination of several of the above molecules).

The sensitizer preferably absorbs the excitation at the first wavelength in order to make maximum use of the energy thereof.

A consideration in selecting a photosensitizer/annihilator pair may include the compatibility of the pair with the photoinitiator being used.

More preferably, at least a portion of the upconverting nanoparticles include a core portion that includes the sensitizer and annihilator in a liquid (e.g., oleic acid) and an encapsulating coating or a shell (e.g., silica) over at least a portion, and preferably substantially all, the outer surface of the core portion. The core can comprise a micelle, that includes the sensitizer and annihilator in a liquid. (A micelle is typically formed from one or more surfactants, e.g., having a relatively hydrophilic portion and a relatively hydrophobic portion.) Examples of preferred upconverting nanoparticles include nanocapsules described in International Application No. PCT/US2019/063629, of Congreve, et al., filed Nov. 27, 2019 which is hereby incorporated herein by reference in its entirety. Other information concerning nanocapsules that may be useful includes International Publication No. WO2015/059179, of Landfester, et al., which published Apr. 30, 2015 and S. Sanders, et al., “Photon Upconversion in Aqueous Nanodroplets”, J. Amer. Chem. Soc. 2019, 141, 9180-9184, each of which is hereby incorporated herein by reference in its entirety.

Upconverting nanoparticles can further include ligands at the surface thereof for facilitating distribution of the nanoparticles in the photopolymerization component. Surfactants and other materials useful as ligands are commercially available. Examples of ligands include, but are not limited to, poly-ethylene glycols.

The photoinitiator can be readily selected by one of ordinary skill in the art, taking into account its suitability for the mechanism to be used to initiate polymerization as well as its suitability for and/or compatibility with the resin to be polymerized. Information concerning photoinitiators that may be useful can be found in WO2019/025717 of Baldeck et al., published Feb. 7, 2019, and International Application No. Application No. PCT/US2019/063629, of Congreve, et al., filed Nov. 27, 2019, each of which is hereby incorporated herein by reference in its entirety.

The photopolymerizable liquid may further include additional additives. Examples of such additives include, but are not limited to, thixotropes, oxygen scavengers, etc. WO2019/025717 of Baldeck et al., published Feb. 7, 2019 provides information that may be useful regarding additives.

Other information that may be useful with the present invention is U.S. Patent Application No. 62/911,125 of Congreve, et al., filed Oct. 4, 2019.

Examples of sources of the excitation light source for use in the methods described herein include laser diodes, such as those available commercially, light emitting diodes, DMD projection systems, micro-LED arrays, vertical cavity lasers (VCLs). In some embodiments, the excitation radiation source (e.g., the light source) is a light-emitting diode (LED).

The systems and methods in accordance with the present invention are particularly useful for printing three-dimensional (3D) objects from photopolymerizable liquids that demonstrate non-Newtonian behavior and which can be solidified at volumetric positions impinged upon by excitation light to form a printed object without requiring the addition of support structures. Support structures are typically required by most 3D printing technologies involving vat polymerization technologies to stabilize the part during printing or to allow printing of thin or fragile overhanging portions of the part; after printing, post-processing is required to remove the support structures, which can damage or leave marks on the printed part. Avoiding addition of support structures would advantageously simplify post-processing of printed parts.

The systems and methods in accordance with the present invention advantageously further do not require adhering the object being printed to a fixed substrate (e.g., build plate) at the beginning of the printing process avoiding a post-processing step of separating the printed object from the fixed substrate.

Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

The systems and methods in accordance with the present invention are additionally particularly useful for printing 3D objects from photopolymerizable liquids that demonstrate non-Newtonian behavior and which can be solidified at volumetric positions impinged upon by excitation light at a first wavelength by upconversion-induced photopolymerization. Preferably, the upconversion comprises triplet upconversion (or triplet-triplet annihilation, TTA) which may be used to produce light of a higher energy relative to light used to photoexcite the sensitizer or annihilator. Most preferably, the sensitizer absorbs low energy light and upconverts it by transferring energy to the annihilator, where two triplet excitons may combine to produce a higher energy singlet exciton that may emit high-frequency or shorter-wavelength light, e.g., via annihilation upconversion.

Preferably the photopolymerizable liquid includes (i) a photopolymerizable component; (ii) upconverting nanoparticles including a sensitizer and a annihilator, the sensitizer comprising molecules selected to absorb light at the first wavelength and generate triplet excitons and the annihilator being selected to emit light at a second wavelength after transfer of energy from the sensitizer to the annihilator, the second wavelength being shorter than the first wavelength; and (iii) a photoinitiator that initiates polymerization of the photopolymerizable component upon excitation by light at the second wavelength. More preferably, the photopolymerizable liquid demonstrates non-Newtonian behavior.

The first and second wavelengths can be in the visible range.

A closed container for use in the systems and methods of the present invention can be a one-piece unit or can be constructed from 2 or more pieces.

A closed container can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic.

Preferably the at least optically transparent portion(s) of the printing zone is (are) also optically flat.

Preferably the photopolymerizable liquid is purged or sparged with an inert gas before being introduced into the closed container and is maintained in an inert atmosphere while in the closed container. The source of the photopolymerizable liquid and the photopolymerizable liquid included in a reservoir used to feed the closed container is also preferably purged and maintained under inert conditions before use in the systems and methods of the present invention.

As shown in FIGS. 1 and 2, the closed container is depicted with an elongated shape. Such configuration facilitates a plurality of printed objects to be printed and moved out of the printing zone, one at a time, by pumping an amount of additional photopolymerizable liquid into the closed container to move the printed object out of the printing zone and introduce a new amount into the printing zone for printing a new object, with displaced contents being discharged from the exit port. After a series of printing parts and adding new photopolymerizable liquid into the printing zone, printed objects will eventually be included in discharged contents and collected after separation from the discharged contents. The separated objects can further be post-treated.

With an alternative design, the length of the channel in the closed container can correspond to the size of the printing zone, with the introduction of new photopolymerizable liquid filling the printing zone and discharging the printed object and unpolymerized photopolymerization liquid from the printing zone and exit port for separation. Other closed container designs may be desirable based on, for example, but not limited to, the number of printing zones and the type and number of optical systems selected.

The closed container channel can have a uniform cross-section over its length between the entry port and the exit port.

The closed container channel can alternatively have a non-uniform cross section. A non-uniform cross-section could be used to manipulate the spacing between successive printed objects, e.g., if the cross section gets larger the parts will move closer together; if the cross section gets smaller the parts will move farther apart. Either scenario could be potentially advantageous for object separation.

The channel can have a circular or oval cross-section. The channel can have a polygonal cross-section. The channel can have a rectangular or square cross-section.

The closed container can optionally further include a conveyor situated at the bottom of the channel to assist in transporting the printed object to the exit port. It can be beneficial for the conveyor to include an antireflective coating on a side of the conveyor that may be impinged upon by the excitation light in the printing zone. Other coatings that could be included one surface of the conveyor (e.g., the surface transporting printed objects) or, optionally both the surface transporting printed objects and the opposite surface of the conveyor, include anti-corrosion or anti-marring coatings. Other coating materials include polymers such as polyolefins and fluoropolymers

The conveyor can be a belt conveyor, including by way of example, but not limited to, a solid belt, a mesh belt, a chain belt. The belt conveyor can likewise benefit from including an antireflective coating on a side of the belt that may be impinged upon by the excitation light in the printing zone. The conveyor can be a trolley or platform made of a magnetizable metal that can be actuated from outside the container using a magnetic field.

A pump for use in the systems and methods of the present invention preferably comprises a hydrostatic pump. Other suitable pumps can be used.

The pump is preferably is capable of (i) pumping the photopolymerizable liquid from the source or reservoir into the closed container to fill the container with the photopolymerizable liquid and (ii) pumping an amount, which can be a metered amount, of the photopolymerizable liquid into the filled closed container to move printed object out of the printing zone in a direction toward the exit port, the exit port being adapted for discharging a portion of contents of the closed container displaced by the amount of the added photopolymerizable liquid through the exit port, out of the closed container.

Optionally the systems and methods of the present invention can include two pumps wherein a first pump is for moving the photopolymerizable liquid to the printing zone and a second pump imparts other flow characteristics to the photopolymerizable liquid. Inclusion of a second pump can be beneficial to compensate for a single pump's potential loss of effectiveness with distance.

Before printing, a digital file of the object to be printed is obtained. If the digital file is not of a format that can be used to print the object, the digital file is then converted to a format that can be used to print the object. An example of a typical format that can be used for printing is an STL file. Typically, the STL file is then sliced into two-dimensional layers with use of three-dimensional slicer software and converted into G-Code or a set of machine commands, which facilitates building the object. See B. Redwood, et al., “The 3D Printing Handbook—Technologies, designs applications”, 3D HUBS B.V. 2018.

When used as a characteristics of a portion of a container or build chamber, “optically transparent” refers to having high optical transmission to the wavelength of light being used, and “optically flat” refers to being non-distorting (e.g., optical wavefronts entering the portion of the container or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A system for printing one or more three-dimensional objects, the system comprising:
a closed container including an entry port and an exit port, the entry port and the exit port being connected by a channel therebetween, the closed container including a printing zone, wherein the printing zone comprises at least an optically transparent window to facilitate directing an excitation light into the printing zone through the optically transparent window to form a three-dimensional printed object within a volume of photopolymerizable liquid in the printing zone, and
a pump in connection with the entry port of the closed container and adapted for connection to a source of the photopolymerizable liquid, the pump being capable of pumping an amount of the photopolymerizable liquid into the closed container through the entry port.

2. (canceled)

3. The system of claim 1 wherein the channel has a uniform cross-section over its length between the entry port and the exit port.

4. (canceled)

5. (canceled)

6. (canceled)

7. The system of claim 1 wherein the closed container is optically transparent.

8. (canceled)

9. (canceled)

10. The system of claim 1 wherein the closed container further includes a conveyor situated at the bottom of the channel to assist in transporting the printed object to the exit port.

11. The system of claim 10 wherein the conveyor comprises an antireflective coating on a side of the conveyor that may be impinged upon by the excitation light in the printing zone.

12. (canceled)

13. (canceled)

14. (canceled)

15. (canceled)

16. (canceled)

17. The system of claim 1 further comprising a separator unit in connection with the exit port of the closed container for receiving contents discharged from the exit port of the closed container, the separator unit for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

18. The system of claim 17 wherein the system further includes a recirculation loop in connection with the second discharge port for recirculating the separated unpolymerized photopolymerizable liquid to the source.

19. (canceled)

20. (canceled)

21. The system of claim 1 wherein the closed container is replaceable.

22. The system of claim 17 wherein the separator unit mechanically separates any printed objects from unpolymerized photopolymerizable liquid.

23. The system of claim 1 wherein the pump is capable of (i) pumping the photopolymerizable liquid from the source into the closed container to fill the container with the photopolymerizable liquid and (ii) pumping a metered amount of the photopolymerizable liquid into the filled closed container to move the printed object out of the printing zone in a direction toward the exit port, the exit port being adapted for discharging contents of the closed container displaced by the metered amount out of the closed container through the exit port.

24. The system of claim 1 further comprising an optical system positioned or positionable to irradiate excitation light through the at least optically transparent window of a printing zone.

25. A system for printing one or more three-dimensional objects, the system comprising:
a reservoir for containing a supply of a photopolymerizable liquid, the reservoir having a reservoir outlet and a reservoir inlet,
a pump in connection with the reservoir outlet for pumping an amount of the photopolymerizable liquid from the reservoir into a closed container through an entry port in the closed container,
the closed container including the entry port and an exit port, the entry port and the exit port being connected by a channel therebetween, the closed container including at least one printing zone, a printing zone comprising at least an optically transparent window to facilitate directing an excitation light at a first wavelength into a printing zone through the optically transparent window to form a three-dimensional printed object from the photopolymerizable liquid in the printing zone, and
a separator unit in connection with the exit port of the closed container for receiving output discharged from the closed container, the separator unit for separating any printed objects from unpolymerized photopolymerizable liquid included in the discharged contents, the separator unit including a first discharge port for discharging any separated printed objects from the separator unit and a second discharge port for discharging the separated unpolymerized photopolymerizable liquid from the separator unit.

26. (canceled)

27. The system of claim 25 wherein the system further includes a recirculation loop in connection with the second discharge port for recirculating the separated unpolymerized photopolymerizable liquid to the reservoir.

28. The system of claim 25 further comprising one or more optical systems positioned or positionable to irradiate excitation light through the optically transparent window of a printing zone.

29. The system of claim 25 wherein the channel has a uniform cross-section over its length between the entry port and the exit port.

30. (canceled)

31. (canceled)

32. (canceled)

33. (canceled)

34. (canceled)

35. (canceled)

36. The system of claim 25 wherein the closed container further includes a conveyor situated at the bottom of the channel to assist in transporting the printed object to the exit port.

37. The system of claim 36 wherein the conveyor comprises an antireflective coating on a side of the conveyor that faces the entry point of the excitation light into the printing zone.

38. (canceled)

39. (canceled)

40. (canceled)

41. (canceled)

42. (canceled)

43. The system of claim 25 wherein the closed container is optically transparent.

44. The system of claim 25 wherein the closed container is replaceable.

45. The system of claim 25 wherein the separator unit mechanically separates the one or more printed objects from the unpolymerized photopolymerizable liquid.

46. (canceled)

47. (canceled)

48. The system of claim 25 wherein the pump is capable of (i) pumping the photopolymerizable liquid from the reservoir into the closed container to fill the container with the photopolymerizable liquid and (ii) pumping a metered amount of the photopolymerizable liquid into the filled closed container to move printed object out of the printing zone in a direction toward the exit port, the exit port being adapted for discharging contents of the closed container displaced by the metered amount out of the closed container through the exit port.

49. A method of printing one or more three-dimensional objects, the method comprising:
providing a volume of a photopolymerizable liquid in a closed container including an entry port and an exit port, the entry port and the exit port being connected by a channel therebetween, the container including at least one printing zone comprising at least an optically transparent window to facilitate irradiating excitation light at a first wavelength into a printing zone through the at least an optically transparent window, wherein the photopolymerizable liquid displays non-Newtonian rheological behavior such that the object formed in the photopolymerizable liquid within the printing zone remains at a fixed position or is minimally displaced in the unpolymerized photopolymerizable liquid during formation,
directing the excitation light through the at least an optically transparent window into the printing zone to selectively photopolymerize the photopolymerizable liquid in the printing zone without support structures to form a printed object, wherein the printed object remains at a fixed position or is minimally displaced in the unpolymerized photopolymerizable liquid during formation, and
applying pressure to the contents of the closed container and/or pumping additional photopolymerizable liquid into the closed container through the entry port to at least transport the printed object out of the printing zone toward the exit port, thereby discharging at least a portion of contents of the closed container out of the closed container through the exit port.

50. (canceled)

51. The method of claim 49 further including separating any printed objects from unpolymerized photopolymerizable liquid included in the discharged contents.

52. The method of claim 49 further comprising recirculating the discharged unpolymerized photopolymerizable liquid after separation of any printed objects to a reservoir.

53. The method of claim 49 wherein minimally displaced comprises displacing the printed object by an amount that is acceptable for precisely reproducing the geometry of the object to be printed during time intervals required to form the object.

54. (canceled)

55. (canceled)

56. (canceled)

57. (canceled)

58. The system of claim 28 wherein an optical system is in connection with an excitation light source.

59. The system of claim 58 wherein the excitation light source comprises a DMD projection system.
